(19) United States
(12) Patent Application Publication
(10) Pub. No.: US 2009/0070389 A1
(43) Pub. Date: Mar. 12, 2009

(54) IMAGE FORMING APPARATUS WITH LOG COLLECTION MECHANISM

(76) Inventor: Teruyuki MARUYAMA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/205,249

(22) Filed: Sep. 5, 2008

(30) Foreign Application Priority Data
Sep. 12, 2007 (JP) 2007-236486

(51) Int. Cl. G06F 17/30

(52) U.S. Cl. 707/201; 707/E17.009

(57) ABSTRACT

An image forming apparatus includes a sorting unit that sorts out a log to be recorded based on filter information, a sending unit that sends a sorted log to a recording destination based on destination information, and an updating unit that updates the filter information and the destination information. The sorting unit and the sending unit perform processing in synchronization with updating by the updating unit.

### CROSS-REFERENCE TO RELATED APPLICATIONS

The present application claims priority to and incorporates by reference the entire contents of Japanese priority document 2007-236486 filed in Japan on Sep. 12, 2007.

### BACKGROUND OF THE INVENTION

1. Field of the Invention

The present invention relates a technology for controlling recording of a system log in an image forming apparatus.

2. Description of the Related Art

In a typical image forming apparatus, a system log is created by computer programs that control the image forming apparatus, and recorded in a log file that is determined by a configuration file at a startup of a system of the image forming apparatus. The log file is created on a local file system of the image forming apparatus, or on a remote file system of a remote device mounted on the local file system.

For example, technologies for determining a recording destination of a log created in a managed device are disclosed in Japanese Patent Application Laid-open No. 2004-295866 and Japanese Patent Application Laid-open No. H07-244645. Specifically, a managed device such as an image forming apparatus is connected to a managing device that is a remote device over a network via a network adapter, and remotely managed by the managing device. A log created by the managed device is transmitted to the managing device based on a configuration file stored in advance in a storage area of the managed device and containing correspondence between log data and a managing device as a recording destination.

However, with the above conventional technologies, information about how a log is to be handled, such as settings of a log to be recorded or a transmission destination of a log, is determined only by the configuration file at a startup of a system. Therefore, it is necessary to restart the system for updating information in the configuration file. Furthermore, the configuration file is updatable only by an operator with root authority and by using a specific application such as a text editor. Thus, handling of a log is not flexible.

### SUMMARY OF THE INVENTION

It is an object of the present invention to at least partially solve the problems in the conventional technology.

According to an aspect of the present invention, there is provided an image forming apparatus that includes a generating unit that generates a log corresponding to an operating status of the image forming apparatus; a collecting unit that collects the log; a filter information storage unit that stores therein filter information for sorting out the log into a first log to be recorded or a second log to be not recorded; a sorting unit that sorts out the log based on the filter information; a destination information storage unit that stores therein destination information containing first information associated with second information, the first information being information for determining a type of the first log, and the second information indicating a recording destination for each type of the first log; a sending unit that sends the first log to a recording destination based on the destination information; a log storage unit that stores therein the first log upon receiving from the sending unit; and an information updating unit that updates the filter information and the destination information in response to an operation from outside, wherein the information updating unit, upon completion of updating of the filter information, notifies the sorting unit of updated filter information, the sorting unit sorts out the log based on the updated filter information from then on, the information updating unit, upon completion of updating of the destination information, notifies the recording unit of updated destination information, and the recording unit records the first log in a recording destination based on the updated destination information from then on.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a system diagram of an image forming apparatus according to a first embodiment of the present invention;

FIG. 2 is a system diagram of an image forming apparatus according to a second embodiment of the present invention;

FIG. 3 is a system diagram of an image forming apparatus according to a third embodiment of the present invention;

FIG. 4 is a functional block diagram of the image forming apparatus shown in FIG. 1;

FIG. 5 is a functional block diagram of a log generating unit shown in FIG. 4;

FIG. 6 is an example of contents of a log;

FIG. 7 is an example of contents of filter information according to the first embodiment;

FIG. 8 is an example of contents of log recording destination information according to the first embodiment;

FIG. 9 is an example of operation contents displayed when a tag for setting a log filter is pressed according to the first embodiment;

FIG. 10 is an example of operation contents displayed when a tag for setting a log recording destination is pressed according to the first embodiment;

FIG. 11 is an example of operation contents displayed on a personal computer according to the second embodiment;

FIG. 12 is an example of operation contents displayed for setting a log filter according to the second embodiment;

FIG. 13 is an example of operation contents displayed for setting a log recording destination according to the second embodiment;

FIG. 14 is an example of contents of a log filter reference command;

FIG. 15 is an example of contents of a log filter reference result;

FIG. 16 is an example of contents of a log filter setting command;

FIG. 17 is an example of contents of a log filter setting result;

FIG. 18 is an example of contents of a log recording destination reference command;

FIG. 19 is an example of contents of log recording destination reference result;

FIG. 20 is an example of contents of a log recording destination setting command;

FIG. 21 is an example of contents of a log filter setting result;

FIG. 22 is a functional block diagram of a log recording unit shown in FIG. 4;

FIG. 23 is a functional block diagram of an information updating unit of the image forming apparatus shown in FIG. 1;

FIG. 24 is a functional block diagram of an information updating unit of the image forming apparatus shown in FIG. 2;

FIG. 25 is a functional block diagram of an information updating unit of the image forming apparatus shown in FIG. 3;

FIG. 26 is a flowchart of a processing procedure performed by the image forming apparatus shown in FIG. 1;

FIG. 27 is a flowchart of a processing procedure performed by the information updating unit shown in FIG. 23;

FIG. 28 is a flowchart of a processing procedure performed by the information updating unit shown in FIG. 24;

FIG. 29 is a flowchart of a processing procedure performed by the information updating unit shown in FIG. 25; and

FIG. 30 is a hardware block diagram of the image forming apparatus shown in FIG. 1.

### DETAILED DESCRIPTION OF THE PREFERRED EMBODIMENTS

Exemplary embodiments of the present invention are described in detail below with reference to the accompanying drawings.

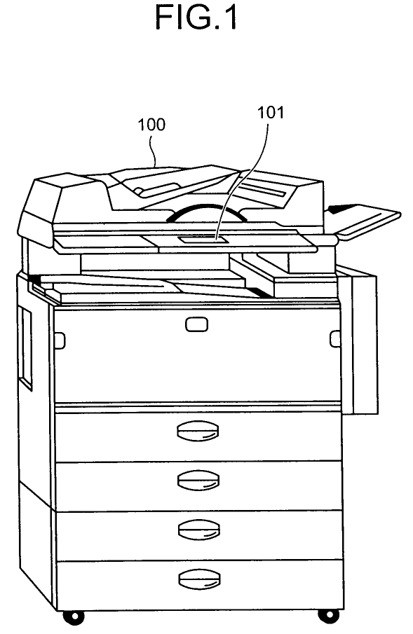

FIG. 1 is a system diagram of an image forming apparatus 100 with a log collection mechanism according to a first embodiment of the present invention. The image forming apparatus 100 includes an operating unit 101.

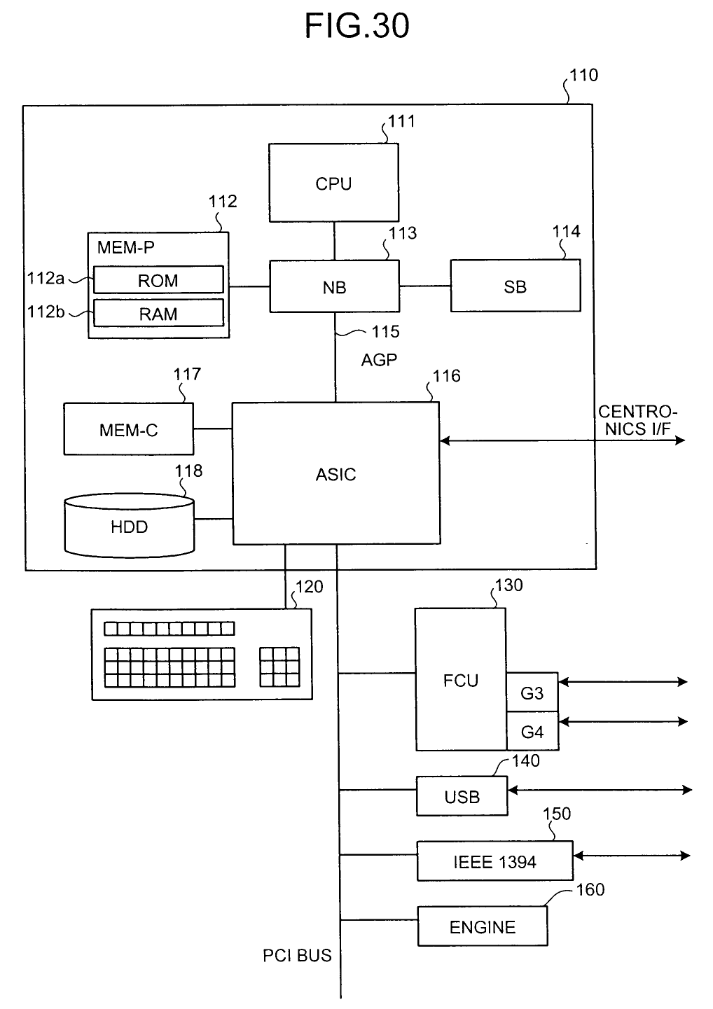

FIG. 30 is a hardware block diagram of the image forming apparatus 100. In the image forming apparatus 100, a controller 110 and an engine 160 are connected to each other by a peripheral component interconnect (PCI) bus. The controller 110 controls the entire image forming apparatus 100 and operations such as drawing, communication, and input from an operating unit (not shown). The engine 160 is, for example, an image forming engine that can be connected to the PCI bus. Examples of the image forming engine include a monochrome plotter, a drum color plotter, a scanner, and a fax unit. The engine 160 includes an image processing unit that performs error diffusion, gamma transformation, and the like as well as an engine unit such as a plotter.

The controller 110 includes a CPU 111, a north bridge (NB) 113, a system memory (MEM-P) 112, a south bridge (SB) 114, a local memory (MEM-C) 117, an application specific integrated circuit (ASIC) 116, and an HDD 118. The NB 113 is connected to the ASIC 116 via an accelerated graphics port (AGP) bus 115. The MEM-P 112 includes a ROM 112a and a RAM 112b.

The CPU 111 controls the entire image forming apparatus 100 and includes a chipset formed of the NB 113, the MEM-P 112, and the SB 114. The CPU 111 is connectable to other units via the chipset.

The NB 113 is a bridge that connects the CPU 111 to the MEM-P 112, the SB 114, and the AGP 115, and includes a memory controller (not shown), a PCI master (not shown), and an AGP target (not shown). The memory controller controls read and write with respect to the MEM-P 112.

The MEM-P 112 is a system memory used as, for example, a memory to store therein computer programs and data, a memory to expand computer programs and data, or a drawing memory of a printer, and includes the ROM 112a and the RAM 112b. The ROM 112a is a read only memory used as a memory to store therein computer programs and data. The RAM 112b is a writable and readable memory used as a memory to expand computer programs and data, and a drawing memory of a printer.

The SB 114 is a bridge that connects the NB 113 to a PCI device (not shown) and a peripheral device (not shown). The SB 114 is connected to the NB 113 via the PCI bus. A network interface (I/F) unit (not shown) and the like are also connected to the PCI bus, and the image forming apparatus 100 is connected to a network 302 via the network interface (I/F) unit.

The ASIC 116 is an integrated circuit (IC) that includes hardware elements for image processing and serves as a bridge that connects the AGP 115, the PCI bus, the HDD 118, and the MEM-C 117 to one another. The ASIC 116 includes, although the following components are not shown, a PCI target, an AGP master, an arbiter (ARB) that serves a main part of the ASIC 116, a memory controller that controls the MEM-C 117, a plurality of direct memory access controllers (DMACs) that rotate image data and the like by hardware logic and the like, and a PCI unit that transfers data to the engine 160 via the PCI bus. A fax control unit (FCU) 130, a USB 140, an IEEE 1394 interface (I/F) 150 are connected to the ASIC 116 via the PCI bus.

The MEM-C 117 is a local memory used as an image buffer for copying and a code buffer. The HDD 118 is a storage device that stores therein image data, computer programs, font data, and form data.

The AGP 115 is a bus I/F for a graphics accelerator card developed to increase the speed of graphic processing, and increases the speed of a graphics accelerator card by directly accessing the MEM-P 112 with high-speed throughput.

An input unit 120 is used for operating the image forming apparatus 100. The input unit 120 can be mechanical buttons or a soft keyboard and buttons arranged on a touch panel.

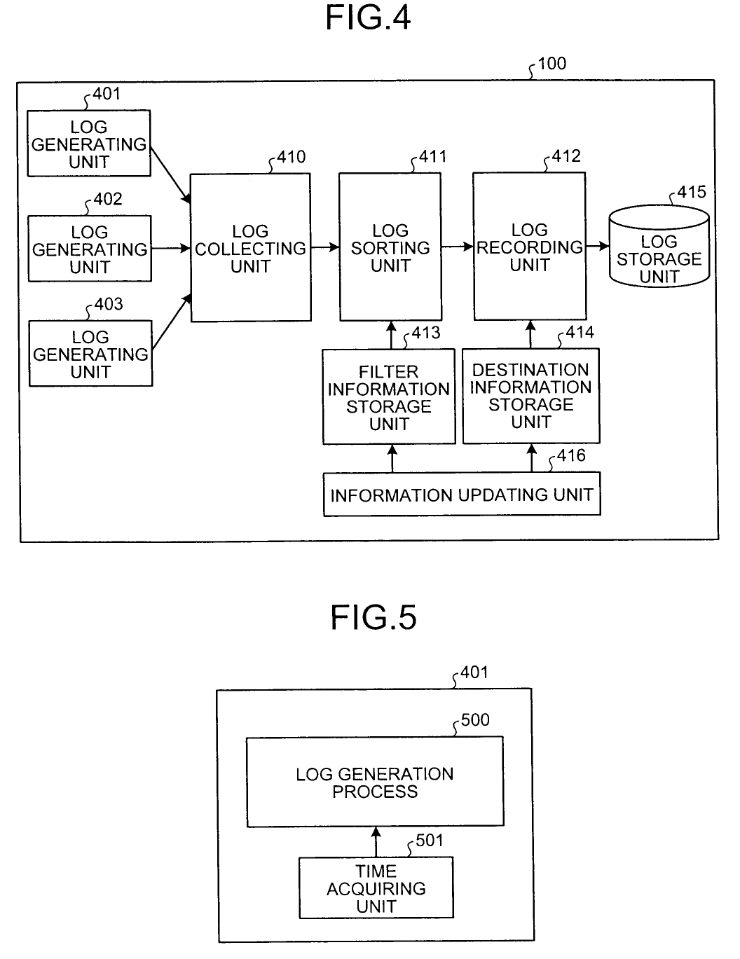

A functional configuration of the image forming apparatus 100 is explained below. FIG. 4 is a functional block diagram of the image forming apparatus 100. The image forming apparatus 100 includes log generating units 401 to 403, a log collecting unit 410, a log sorting unit 411, a log recording unit 412, a filter information storage unit 413, a destination information storage unit 414, an information updating unit 416, and a log storage unit 415. The log collecting unit 410 performs a socket communication with three computer programs of the log generating units 401 to 403, and collects a log generated by the computer programs. The log sorting unit 411, based on filter information stored in the filter information storage unit 413, sorts out the log acquired by the log collecting unit 410 into a log that needs to be recorded or a log that does not need to be recorded. The log recording unit 412, based on the log recording destination information stored in the destination information storage unit 414, records a log in the log storage unit 415. The information updating unit 416 updates the filter information and the log recording destination information based on an operation performed by the operating unit 101.

Each constituent of the log generating units 401 to 403, the log collecting unit 410, the log sorting unit 411, the log recording unit 412, and the information updating unit 416 can be provided as a computer program stored in advance in a ROM and the like. In the first embodiment, the computer program is stored in the ROM 112a or the HDD 118, and each of the above constituents is created on the RAM 112b by being read and executed by the CPU 111 via the NB 113 or via the NB 113 and the ASIC 116. The operating unit 101 is the input unit 120, and the log storage unit 415 as a local memory is, for example, the HDD 118.

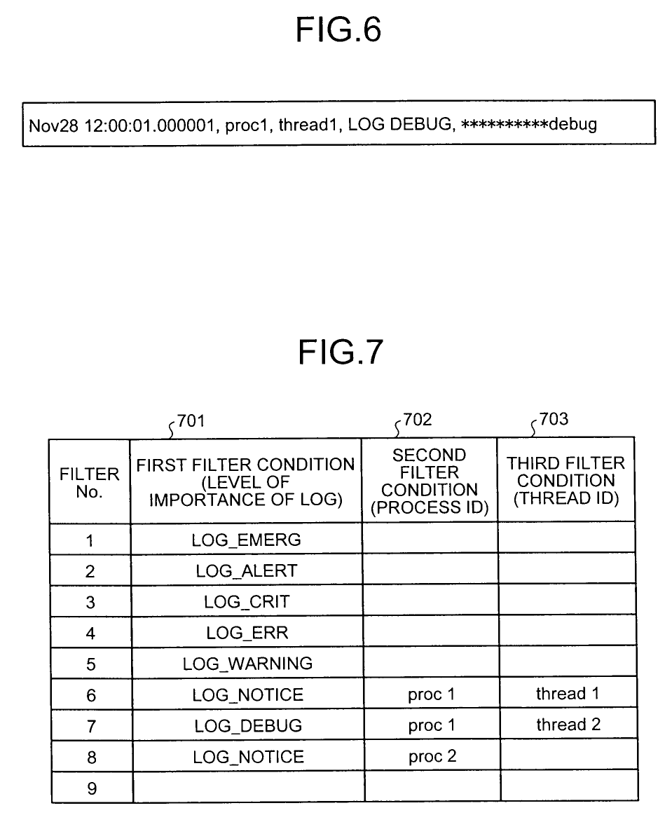

FIG. 5 is a functional block diagram of the log generating unit 401. The log generating unit 401 includes a log generation process 500 for generating a log, and a time acquiring unit 501 that acquires log generation time. The log generating units 402 and 403 have the same configurations and functions as those of the log generating unit 401. FIG. 6 is an example of contents of a log generated by the log generating unit 401. The log contains time and date when the log was generated (in this case, November 28 12:00:01.000001), ID information to specify a process that generated the log (in this case, proc 1), ID information to specify a thread that generated the log (in this case, thread 1), information that indicates the level of importance of the log (in this case, LOG_DEBUG), and an actual message of the log (in this case, **********debug).

FIG. 7 is an example of contents of filter information stored in the filter information storage unit 413. The filter information contains a filter number that specifies a filter, a first filter condition 701 related to the level of importance of a log, a second filter condition 702 related to a process ID of a process by which a log was generated, and a third filter condition 703 related to a thread ID of a thread by which a log was generated. The filter information is managed in a table as shown in FIG. 7. In the example shown in FIG. 7, logs that have the level of importance of LOG_EMERG, LOG_ALERT, LOG_CRIT, LOG_ERR, or LOG_WARNING are to be recorded irrespective of the process ID or the thread ID. Furthermore, logs containing the level of importance of LOG_NOTICE, the process ID of proc 1, and the thread ID of thread 1, logs containing the level of importance of LOG_DEBUG, the process ID of proc 1, and the thread ID of thread 2, and logs containing the level of importance of LOG_NOTICE and the process ID of proc 2 are to be recorded.

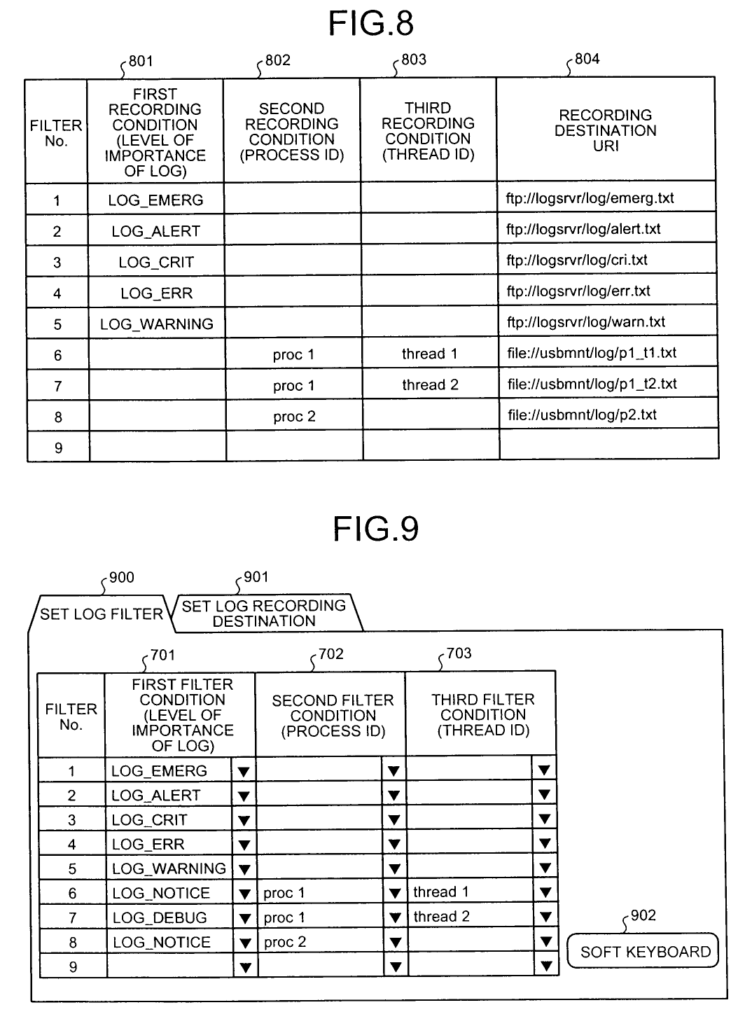

FIG. 8 is an example of contents of log recording destination information stored in the destination information storage unit 414. The log recording destination information contains a filter number that specifies a unit (type) of logs to be recorded, a first recording condition 801 related to the level of importance of a log, a second recording condition 802 related to the process ID of a process by which a log was generated, a third recording condition 803 related to the thread ID of a thread by which a log was generated, and recording destination information 804 indicating a recording destination of a log that satisfies the above three conditions. The log recording destination information is managed in a table as shown in FIG. 8. The recording destination information 804 is identified by a uniform resource identifier (URI), and can specify a log file on a local file system or on a server communicable by using file transfer protocol (FTP).

FIG. 22 is a functional block diagram of the log recording unit 412. The log recording unit 412 includes a destination URI acquiring unit 2200, a log file writing unit 2201, a log file transferring unit 2202, and a network communication unit 2203. The log recording unit 412 receives a log sorted and output by the log sorting unit 411, and extracts information about the level of importance of the log, the process ID, and the thread ID from the log. Upon reference to a log recording destination URI acquired by the destination URI acquiring unit 2200, if the URI indicates a file on the local file system, the log file writing unit 2201 writes a target log to a file in the log storage unit 415. On the other hand, upon reference to the log recording destination URI acquired by the destination URI acquiring unit 2200, if the URI indicates a file on a server communicable by FTP, the log file transferring unit 2202 communicates with the server using FTP protocol, and writes the target log to a file on the server over the network 302 via the network communication unit 2203. Communication protocols are not limited to FTP and can be others such as hypertext transfer protocol (HTTP) and hypertext transfer protocol secure (HTTPS).

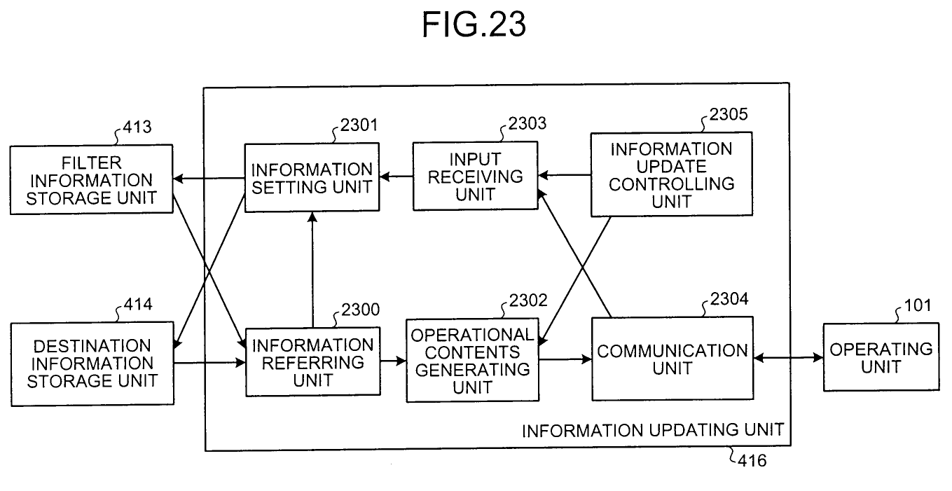

FIG. 23 is a functional block diagram of the information updating unit 416. The information updating unit 416 includes an information referring unit 2300, an information setting unit 2301, an operational contents generating unit 2302, an input receiving unit 2303, a communication unit 2304 that communicates with the operating unit 101, and an information update controlling unit 2305. The information update controlling unit 2305 controls the operational contents generating unit 2302 to generate operational contents based on the filter information and the log recording destination information acquired by the information referring unit 2300. Then, the information update controlling unit 2305 displays the operational contents on the operating unit 101 via the communication unit 2304. With an input from the operating unit 101 via the communication unit 2304, the information update controlling unit 2305 controls the input receiving unit 2303 to receive updated filter information and log recording destination information. Then, the information update controlling unit 2305 updates the filter information in the filter information storage unit 413 and the log recording destination information in the destination information storage unit 414 via the information setting unit 2301. Upon completion of setting of the filter information, the information setting unit 2301 issues a signal to the log sorting unit 411 to request the log sorting unit 411 to refer to the updated filter information. Similarly, upon completion of setting of the log recording destination information, the information setting unit 2301 issues a signal to the log recording unit 412 to request the log recording unit 412 to refer to the updated log recording destination information.

FIG. 9 is an example of operation contents for setting a log filter. The operating unit 101 includes a liquid crystal display unit and a touch panel configured such that buttons or the like corresponding to operations are displayed so that operations can be selected and executed.

When a tag 900 for setting a log filter is pressed, a current setting status of the log filter is displayed as shown in FIG. 9. When an item of the first filter condition 701, the second filter condition 702, and the third filter condition 703 is pressed, a pressed item is selected. In this state, when a button 902 for displaying a soft keyboard is pressed, the soft keyboard is displayed for enabling a user to enter a text into the selected item from the touch panel.

It is also possible to display a list of current selectable conditions and select a condition from the list by pressing a reverse triangle shape at the right end of each item of the first filter condition 701, the second filter condition 702, and the third filter condition 703.

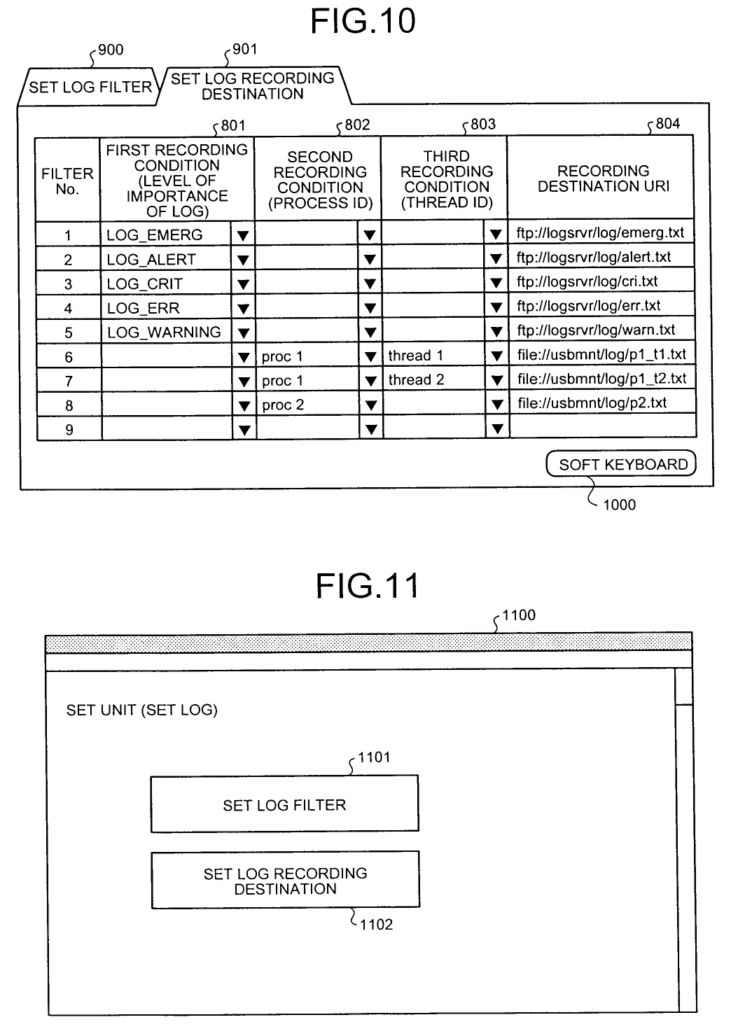

FIG. 10 is an example of operation contents for setting a log recording destination. When a tag 901 for setting a log recording destination is pressed, a current setting status of a log recording destination is displayed. When an item of the first recording condition 801, the second recording condition 802, and the third recording condition 803 of each recording item is pressed, a pressed item is selected. When a button 1000 for displaying a soft keyboard is pressed, the soft keyboard is displayed for enabling a user to enter a text into the selected item from the touch panel.

It is also possible to display a list of current selectable conditions and select a condition from the list by pressing a reverse triangle shape at the right end of each item of the first recording condition 801, the second recording condition 802, and the third recording condition 803 of each recording item.

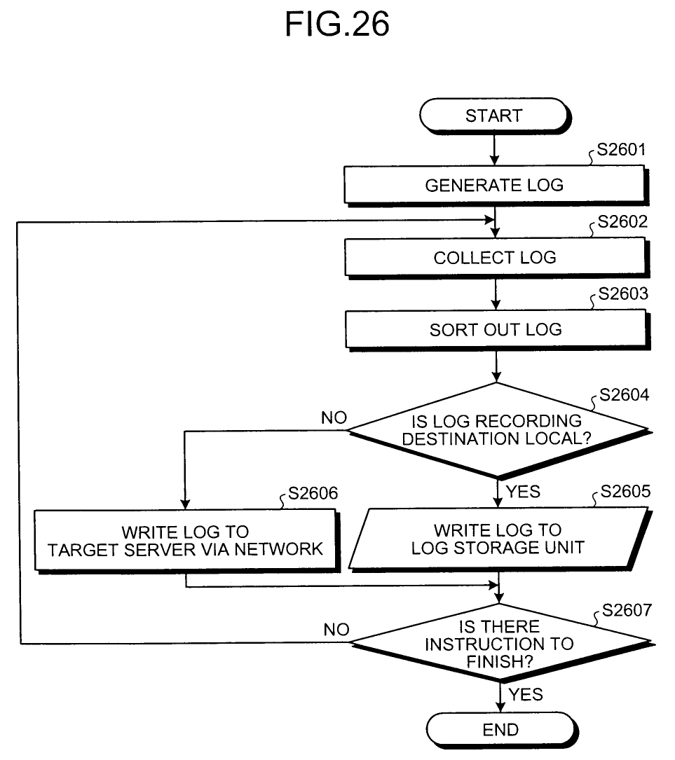

An operation performed by the image forming apparatus 100 is explained below. FIG. 26 is a flowchart a processing procedure of collecting, sorting, and recording a log, performed by the image forming apparatus 100.

The process 500 generates a log by referring to data in the time acquiring unit 501 (Step S2601). The process 500 is a computer program for generating a log included in the log generating units 401 to 403. From then on, the log generating units 401 to 403 generate a log every time an event that generates a log occurs.

The log collecting unit 410 performs a socket communication with the computer programs of the log generating units 401 to 403 and collects logs generated by the computer programs (Step S2602). Then, the log sorting unit 411, based on the filter information acquired by the filter information storage unit 413, sorts out the logs acquired by the log collecting unit 410 into a log that needs to be recorded and a log that does not need to be recorded (Step S2603).

It is determined, for each acquired log, whether a recording destination URI indicates a file on the local file system based on the log recording destination URI acquired by the destination URI acquiring unit 2200 (Step S2604). If the recording destination URI indicates the file on the local file system (Yes at Step S2604), the log file writing unit 2201 writes a target log to a file in the log storage unit 415 (Step S2605). If the recording destination URI does not indicate the file on the local file system (No at Step S2604), the log file transferring unit 2202 transfers the target log obtained from the log sorting unit 411 to the file on the server specified by the log recording destination URI over the network 302 via the network communication unit 2203 (Step S2606).

After completion of processing at Step S2605 or Step S2606, process control proceeds to Step S2607. It is determined whether there is an instruction to finish the operation of collecting, sorting, and recording a log (Step S2607). If there is an instruction to finish (Yes at Step S2607), operations of collecting, sorting, and recording a log end. If there is no instruction to finish (No at Step S2607), process control returns to Step S2602.

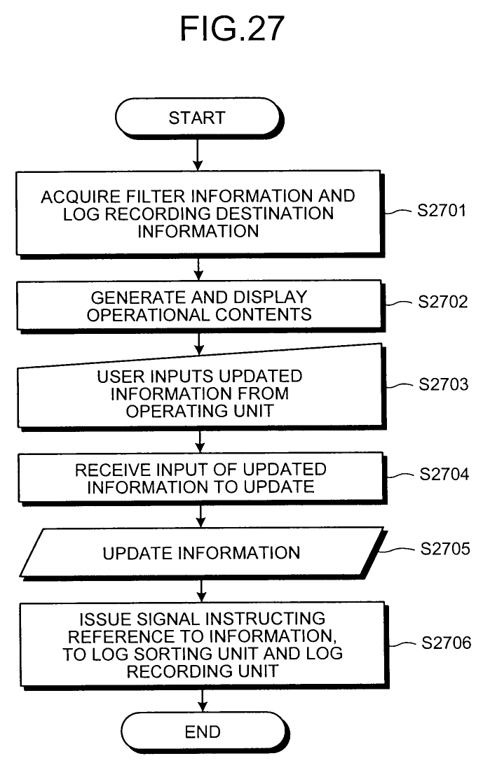

According to the first embodiment, a user can change the filter information used at Step S2603 and the log recording destination information used at Step S2604. An operation of changing the filter information and the log recording destination information is explained below. FIG. 27 is a flowchart of a processing procedure for changing the filter information and the log recording destination information by a user.

The information update controlling unit 2305 controls the information referring unit 2300 to acquire filter information and log recording destination information (Step S2701). The information update controlling unit 2305 controls the operational contents generating unit 2302 to generate operation contents, and displays the operation contents on a liquid crystal display unit in the operating unit 101 (Step S2702).

The user operates the operation contents displayed on the liquid crystal display unit (see FIGS. 9 and 10) by using the touch panel on the liquid crystal display unit, and updates each piece of information (Step S2703). The information update controlling unit 2305 then controls the input receiving unit 2303, and receives updated filter information and log recording destination information from the operating unit 101 via the communication unit 2304 (Step S2704). The information update controlling unit 2305 then updates the filter information in the filter information storage unit 413 and the log recording destination information in the destination information storage unit 414 via the information setting unit 2301 (Step S2705).

Upon completion of updating of the filter information, the information setting unit 2301 issues a signal to the log sorting unit 411 and instructs the log sorting unit 411 to refer to the updated filter information (Step S2706). Furthermore, upon completion of updating of the log recording destination information, the information setting unit 2301 issues a signal to the log recording unit 412 to request the log recording unit 412 to refer to the updated log recording destination information (Step S2706).

As described above, according to the first embodiment, it is possible to provide an image forming apparatus with a log collection mechanism that can flexibly change setting information about a log to be recorded, a log transmission destination, and the like.

More specifically, even if the image forming apparatus is in operation, setting information about a log filter and a log recording destination can be set, and sorting process and recording process can be performed in synchronization with updating of the setting information. Concretely, it is possible to collect desired log information in a desired recording medium at a desired timing. Because a log can be sorted out by the level of importance of a log, the process ID, and the thread ID, it is possible to eliminate unnecessary logs. Because a URI can be specified as a recording destination of the log for each level of importance of the log, the log can be collected on the local file system or on an outside server connected to the network depending on the level of importance of the log. Accordingly, it is possible to selectively collect logs. Because a URI can be specified as the recording destination of the log for each process and thread by which the log was generated, the log can be collected on the local file system or on the outside server connected to the network depending on the process and the thread. Accordingly, it is possible to selectively collect logs. With the operating unit 101, even if the image forming apparatus is not connected to a network, it is possible to set the log filter and the log recording destination individually and in detail.

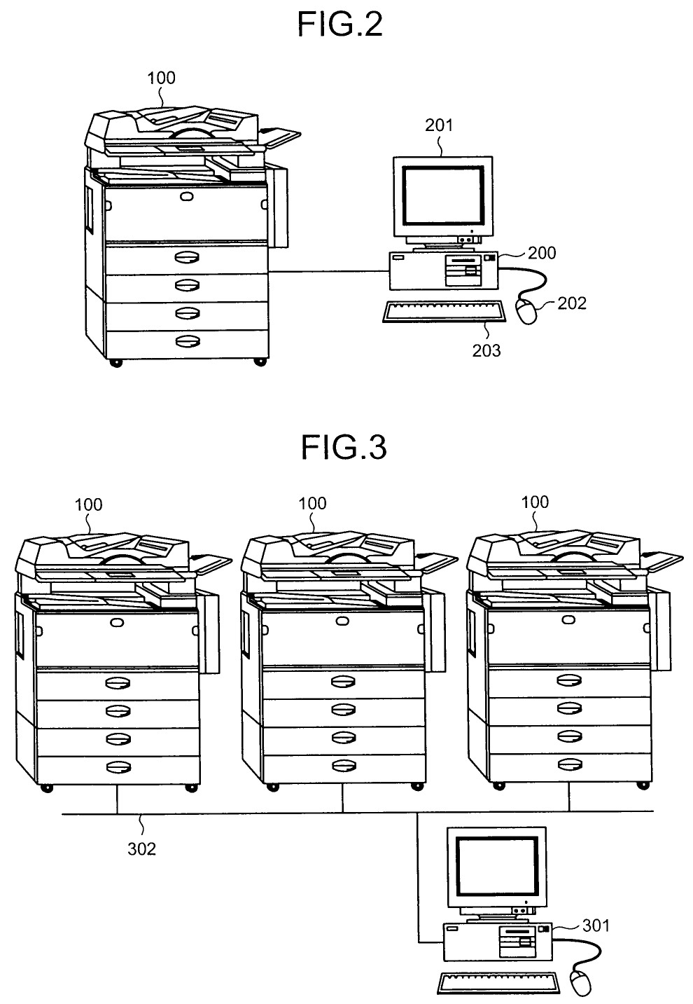

FIG. 2 is a system diagram of the image forming apparatus 100 according to a second embodiment of the present invention. The image forming apparatus 100 is connected to a PC 200 via a network. The PC 200 includes a controlling device such as a CPU, a storage device such as a ROM and a RAM, an external storage device such as an HDD and a compact disk (CD) drive device, a display unit 201 such as a display device, and an input device including a keyboard 203 and a pointing device 202 such as a mouse. The hardware configuration of the image forming apparatus 100 according to the second embodiment is the same as that described in the first embodiment; however, the operating unit 101 is not necessary. A functional configuration of the information updating unit 416 according to the second embodiment is different from that of the first embodiment, and therefore, only description thereof is given below.

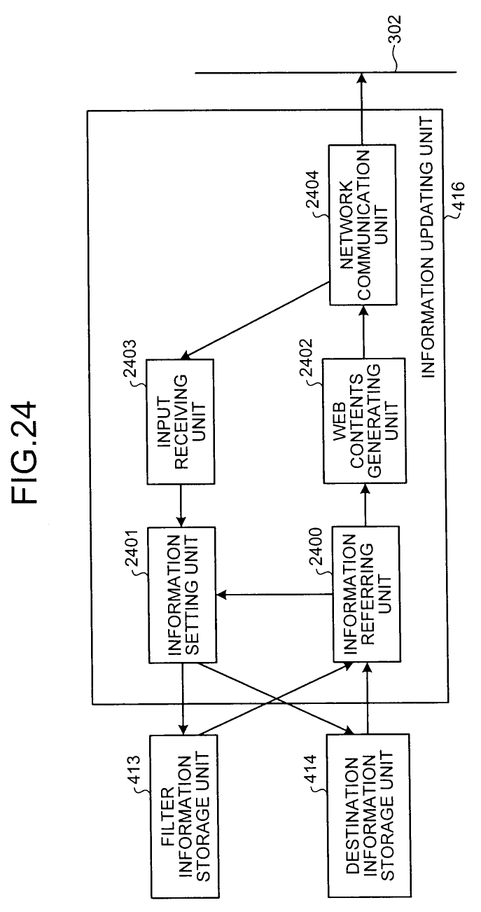

FIG. 24 is a functional block diagram of the information updating unit 416 according to the second embodiment. The information updating unit 416 includes an information referring unit 2400, an information setting unit 2401, a Web contents generating unit 2402, an input receiving unit 2403, and a network communication unit 2404. The network communication unit 2404 requests the Web contents generating unit 2402 to generate Web contents in response to a request for Web contents from a PC connected via the network 302. The Web contents generating unit 2402 generates Web contents based on the filter information and the log recording destination information acquired by the information referring unit 2400, and provides the Web contents to the PC, which is a source of the request, via the network communication unit 2404.

The input receiving unit 2403 receives input of updating of the filter information and the log recording destination information from the PC via the network communication unit 2404. Then, the information setting unit 2401 updates the information in the filter information storage unit 413 and the destination information storage unit 414. Upon completion of setting (updating) of the filter information, the information setting unit 2401 issues a signal to the log sorting unit 411 to request the log sorting unit 411 to refer to the updated filter information. Upon completion of setting of the log recording destination information, the information setting unit 2401 issues a signal to the log recording unit 412 to request the log recording unit 412 to refer to the updated log recording destination information.

FIG. 11 is an example of Web contents 1100 displayed in response to the request for the Web contents from the PC. The Web contents 1100 is used for setting a log, and includes a button 1101 for shifting to a setting page of the log filter, and a button 1102 for shifting to a setting page of the log recording destination.

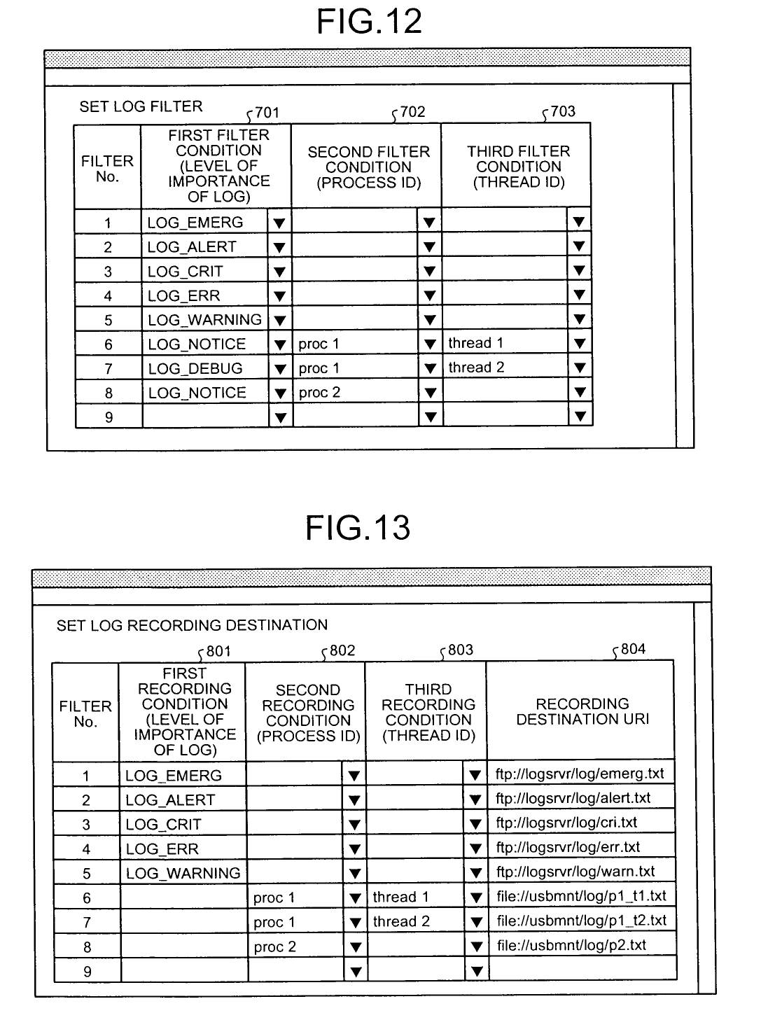

FIG. 12 is an example of Web contents to be displayed on a Web browser for setting the log filter. Current setting status of the log filter is displayed in response to a request of setting the log filter. When a user clicks an item of the first filter condition 701, the second filter condition 702, and the third filter condition 703 by using a mouse, a clicked item is selected, making it possible to enter a text into the selected item from the keyboard. It is also possible to display a list of current selectable conditions so that a user can select a condition from the list by clicking a reverse triangle shape at the right end of each item of the first filter condition 701, the second filter condition 702, and the third filter condition 703 by a mouse.

FIG. 13 is an example of Web contents displayed on the Web browser for setting the log recording destination. Current setting status of the log recording destination is displayed in response to a request of setting the log recording destination. When a user clicks an item of the first recording condition 801, the second recording condition 802, and the third recording condition 803 by using a mouse, the clicked item is selected, making it possible to enter a text into the selected item from the keyboard. It is also possible to display a list of current selectable conditions so that a user can select a condition from the list by clicking a reverse triangle shape at the right end of each item of the first recording condition 801, the second recording condition 802, and the third recording condition 803 by a mouse.

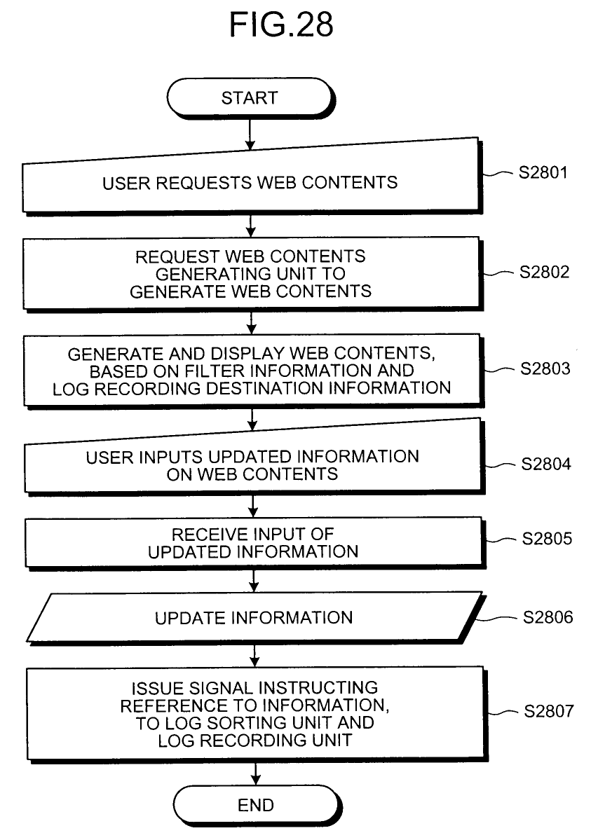

An operation performed by the image forming apparatus 100 according to the second embodiment is explained below. Because the operations of collecting, selecting, and recording a log are the same as those described in the first embodiment, descriptions thereof are omitted. An operation for changing (updating) the filter information and the log recording destination information based on an operation by a user, which is different from the first embodiment, is explained below. FIG. 28 is a flowchart of a processing procedure for changing the filter information and the log recording destination information based on an operation by a user.

A user requests for Web contents by using the pointing device 202 and the keyboard 203 in the PC 200 (Step S2801). The network communication unit 2404 that received the request for the Web contents via the network 302 requests the Web contents generating unit 2402 to generate Web contents (Step S2802). The Web contents generating unit 2402 then generates the Web contents (see FIGS. 11 to 13) based on the filter information and the log recording destination information acquired by the information referring unit 2400. The Web contents generating unit 2402 then provides the Web contents to the PC, which is the source of the request, via the network communication unit 2404 (Step S2803).

The user then updates information of the Web contents displayed on the display unit 201 of the PC 200 by using the pointing device 202 and the keyboard 203 (Step S2804). When the network communication unit 2404 receives updated information via the network 302, the network communication unit 2404 sends the updated information to the input receiving unit 2403. The input receiving unit 2403 then receives the updated information (the filter information and the log recording destination information), and sends it to the information setting unit 2401 (Step S2805). The information setting unit 2401 receives the updated information, and then updates the information in the filter information storage unit 413 and the destination information storage unit 414 (Step S2806).

Upon completion of setting (updating) of the filter information, the information setting unit 2401 issues a signal to the log sorting unit 411 to request the log sorting unit 411 to refer to the updated filter information (Step S2807). Furthermore, upon completion of setting (updating) of the log recording destination information, the information setting unit 2401 issues a signal to the log recording unit 412 to request the log recording unit 412 to refer to the updated log recording destination information (Step S2807).

As described above, according to the second embodiment, it is possible to set the log filter and the log recording destination individually and in detail using the Web contents.

FIG. 3 is a system diagram of the image forming apparatus 100 according to a third embodiment of the present invention. A plurality of the image forming apparatuses 100 are connected to a Web service client 301 via the network 302. The Web service client 301 is an arithmetic and logic device such as the PC 200 in the second embodiment, and includes an arithmetic and logic unit (not shown), a storage unit (not shown), a display unit, and an input unit.

The hardware configuration of each of the image forming apparatuses 100 is the same as that described in the first embodiment; however, the operating unit 101 is not necessary. A functional configuration of the information updating unit 416 is different from that described in the first embodiment, and therefore, only a description thereof is given below.

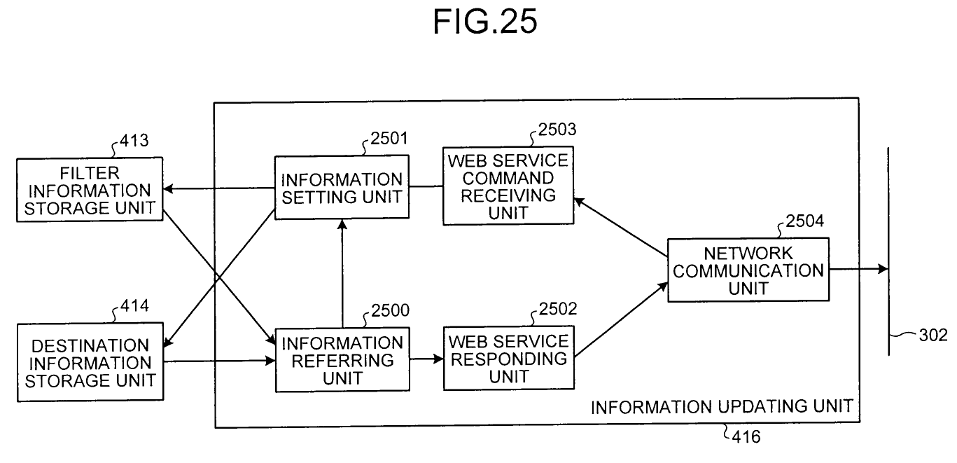

FIG. 25 is a functional block diagram of the information updating unit 416 according to the third embodiment. The information updating unit 416 includes an information referring unit 2500, an information setting unit 2501, a Web service responding unit 2502, a Web service command receiving unit 2503, and a network communication unit 2504. The Web service command receiving unit 2503 receives a command from the Web service client 301 that is connected over the network 302 via the network communication unit 2504.

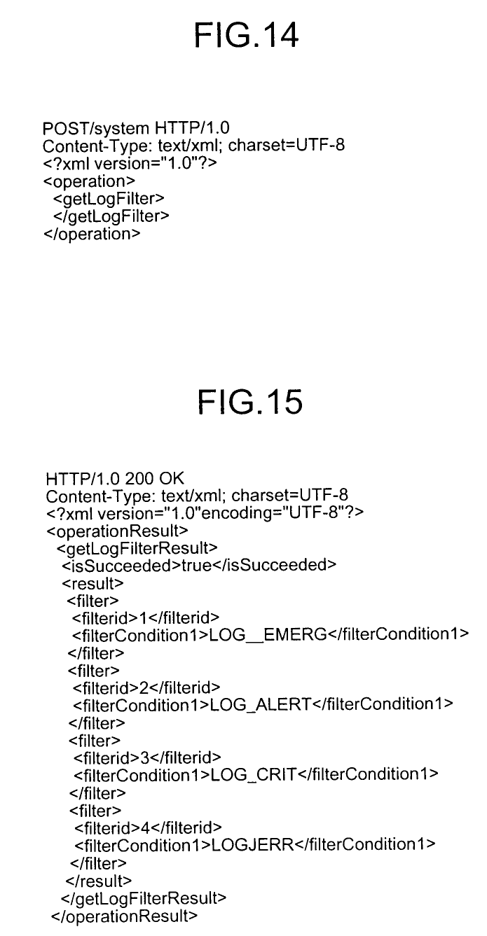

Explanation about contents of a command that requests reference to the filter information and the log recording destination information is given below. FIG. 14 is an example of contents of a log filter reference command instructing reference to the filter information. The log filter reference command requests to refer to a log filter with a tag <getLogFilter></getLogFilter> written in the fifth and the sixth lines. This command requests the Web service responding unit 2502 to return a reference result of the log filter. The Web service responding unit 2502, based on the filter information acquired by the information referring unit 2500, generates a reference result of the log filter as shown in FIG. 15, and returns the reference result to the Web service client over the network 302 via the network communication unit 2504. In the example shown in FIG. 15, a portion separated by a <result> tag and a </result> tag indicates a filter condition for each filter ID.

It is also possible to enter a command that requests to refer to the log recording destination information. FIG. 18 is an example of contents of a log recording destination reference command. The log recording destination reference command requests to refer to the log recording destination with a tag <getLogDestination></getLogDestination> written in the fifth and the sixth lines. The log recording destination reference command requests the Web service responding unit 2502 to return a reference result of the log recording destination. The Web service responding unit 2502, based on the log recording destination information acquired by the information referring unit 2500, generates a reference result of the log recording destination (see FIG. 19), and returns the reference result to the Web service client over the network 302 via the network communication unit 2504. In the example shown in FIG. 19, a portion separated by the <result> tag and the </result> tag indicates the filter condition and the log recording destination information for each filter ID.

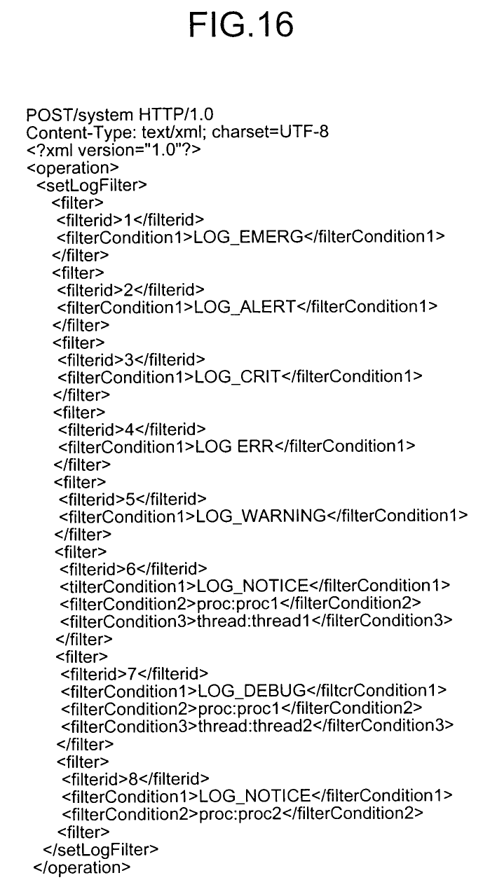

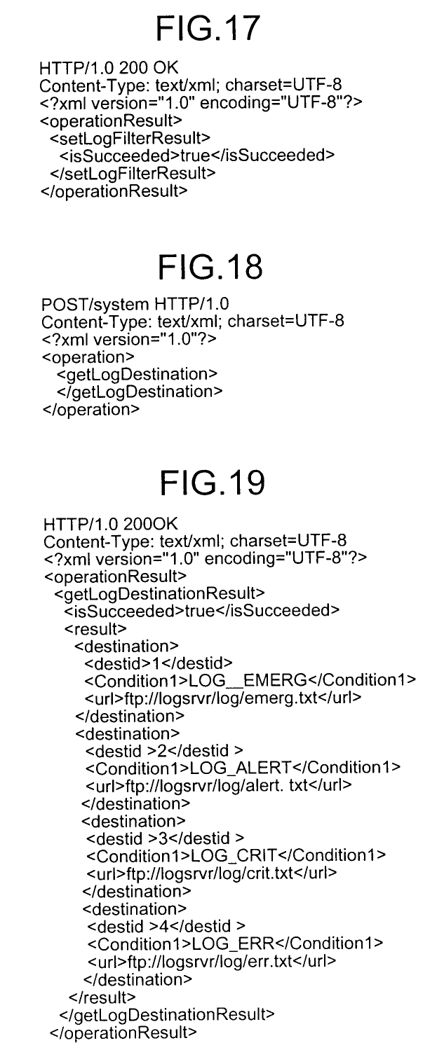

Explanation about a setting command of the filter information and the log recording destination information is given below. FIG. 16 is an example of contents of a log filter setting command. In the log filter setting command, settings of a desired log filter is written for each filter ID in lines between a <setLogFilter> tag and a </setLogFilter> tag. With the log filter setting command, the information in the filter information storage unit 413 is updated via the information setting unit 2501. A setting result of the log filter as shown in FIG. 17 is returned to the Web service client by the Web service responding unit 2502. The setting result contains information represented by <isSucceeded>true</isSucceeded>, which indicates that the update of the setting of the log filter has succeeded.

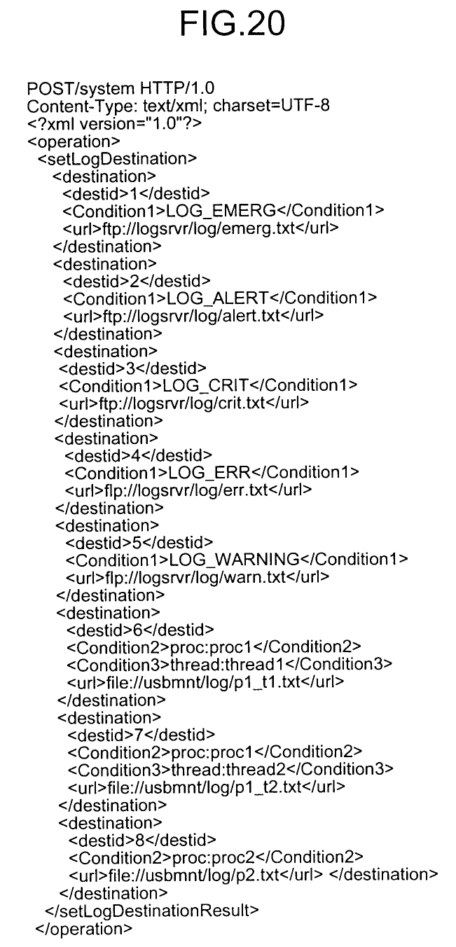

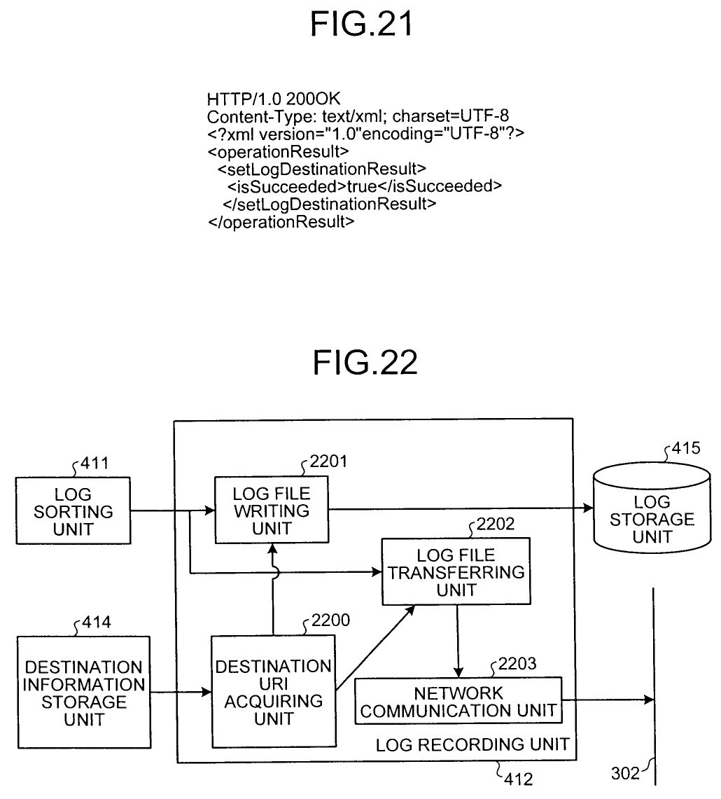

FIG. 20 is an example of contents of a log recording destination setting command. In the log recording destination setting command, the log filter condition and a desired log recording destination are written for each filter ID in lines between a <setLogDestination> tag and a </setLogDestination> tag. With the log recording destination setting command, the information in the destination information storage unit 414 is updated via the information setting unit 2501, and a setting result of the log recording destination as shown in FIG. 21 is returned to the Web service client by the Web service responding unit 2502. The setting result contains information represented by <isSucceeded>true</isSucceeded>, which indicates that the update of the setting of the recording destination has succeeded.

Upon completion of setting (updating) of the filter information, the information setting unit 2501 issues a signal to the log sorting unit 411 to request the log sorting unit 411 to refer to the updated filter information. Upon completion of setting (updating) of the log recording destination information, the information setting unit 2501 issues a signal to the log recording unit 412 to request the log recording unit 412 to refer to the updated log recording destination information.

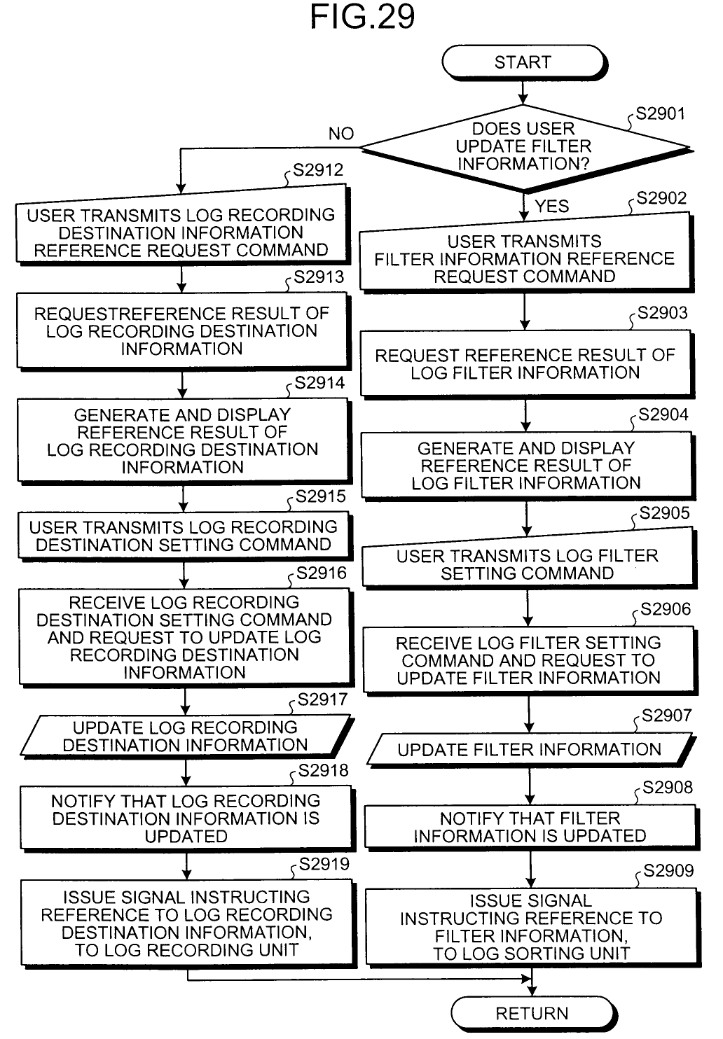

An operation performed by the image forming apparatus 100 according to the third embodiment is described below. Because the operations of collecting, sorting, and recording a log are the same as those described in the first embodiment, the descriptions thereof are omitted. An operation for updating the filter information and the log recording destination information based on an operation by a user, which is different from that of the first embodiment, is explained below. FIG. 29 is a flowchart of processing procedure for updating the filter information and the log recording destination information based on an operation by a user.

A user determines whether to update the filter information (Step S2901). If the filter information is to be updated (Yes at Step S2901), process control proceeds to Step S2902. If the filter information is not to be updated (No at Step S2901), process control proceeds to Step S2912.

At Step S2902, the user transmits a request command to refer to the filter information (for example, FIG. 14), by using the Web service client 301. The Web service command receiving unit 2503, upon receipt of the request command from the Web service client 301 connected over the network 302 via the network communication unit 2504, requests the Web service responding unit 2502 to return a reference result of the log filter (Step S2903). The Web service responding unit 2502, based on the filter information acquired by the information referring unit 2500, generates the reference result of the log filter as shown in FIG. 15, and returns the reference result to the Web service client 301 over the network 302 via the network communication unit 2504 (Step S2904).

The user checks settings at this point based on the reference result as shown in FIG. 15, and if the user desires to update the settings, transmits the log filter setting command (for example, FIG. 16) from the Web service client 301 (Step S2905). The Web service command receiving unit 2503, upon receipt of the command from the Web service client 301 connected over the network 302 via the network communication unit 2504, requests the information setting unit 2501 to update the filter information (Step S2906). The information setting unit 2501 then updates the filter information in the filter information storage unit 413 (Step S2907).

Subsequently, the Web service responding unit 2502 returns the setting result of the log filter (see FIG. 17) to the Web service client 301, so that the user is notified that the information is updated (Step S2908). The information setting unit 2501 issues a signal to the log sorting unit 411 to request the log sorting unit 411 to refer to the updated filter information (Step S2909).

When the filter information is not to be updated at Step S2901 (No at Step S2901), process control proceeds to Step S2912. By using the Web service client 301, the user transmits a request command to refer to the log recording destination information (for example, FIG. 18). The Web service command receiving unit 2503, upon receipt of the request command from the Web service client 301 connected over the network 302 via the network communication unit 2504, requests the Web service responding unit 2502 to return a reference result of the log recording destination information (Step S2913). The Web service responding unit 2502, based on the log recording destination information acquired by the information referring unit 2500, generates the reference result of the log recording destination information as shown in FIG. 19, and returns the reference result to the Web service client 301 over the network 302 via the network communication unit 2504 (Step S2914).

The user checks settings at this point based on the reference result as shown in FIG. 15, and if the user desires to update the settings, transmits a log recording destination setting command (for example, FIG. 20), from the Web service client 301 (Step S2915). The Web service command receiving unit 2503, upon receipt of the command from the Web service client 301 connected over the network 302 via the network communication unit 2504, requests the information setting unit 2501 to update the log recording destination information (Step S2916). The information setting unit 2501 then updates the log recording destination information in the destination information storage unit 414 (Step S2917).

Subsequently, the Web service responding unit 2502 returns the setting result of the log recording destination information (see FIG. 21) to the Web service client 301, so that the user is notified that the information is updated (Step S2918). The information setting unit 2501 issues a signal to the log recording unit 412 to request the log recording unit 412 to refer to the updated log recording destination information (Step S2919).

After completion of processing at Step S2909 or Step S2919, the operation to update the filter information and the log recording destination information is finished.

As described above, according to the third embodiment, it is possible to set the log filter and the log recording destination of the image forming apparatuses, from one Web service client. Accordingly, it is possible to improve the efficiency of the setting process.

According to an aspect of the present invention, even if the image forming apparatus is in operation, setting information about a log filter and a log recording destination can be set, and sorting process and recording process can be performed in synchronization with updating of the setting information. Accordingly, it is possible to collect desired log information in a desired recording medium at a desired timing.

According to anther aspect of the present invention, the image forming apparatus can sort out a log by the level of importance of the log, the process ID, and the thread ID. Accordingly, it is possible to eliminate unnecessary logs.

According to still another aspect of the present invention, a URI can be specified as a recording destination of the log for each level of importance of the log. Accordingly, the log can be collected on the local file system or on the outside server connected to the network depending on the level of importance of the log. Thus, it is possible to selectively collect the log.

According to still another aspect of the present invention, a URI can be specified as a recording destination of the log for each process and thread by which the log was generated. Accordingly, the log can be collected on the local file system or on the outside server connected to the network depending on the process and the thread. Accordingly, it is possible to selectively collect the log.

According to still another aspect of the present invention, even when the image forming apparatus is not connected to the network, setting information about the log filter and the log recording destination can be set or updated individually and in detail by using an operating unit in the image forming apparatus.

According to still another aspect of the present invention, the log filter and the log recording destination can be set individually and in detail using the Web contents.

According to still another aspect of the present invention, the log filter and the log recording destination can be set from one Web service client through a Web service. Accordingly, it is possible to efficiently perform the setting.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a generating unit that generates a log corresponding to an operating status of the image forming apparatus;
a collecting unit that collects the log;
a filter information storage unit that stores therein filter information for sorting out the log into a first log to be recorded or a second log to be not recorded;
a sorting unit that sorts out the log based on the filter information;
a destination information storage unit that stores therein destination information containing first information associated with second information, the first information being information for determining a type of the first log, and the second information indicating a recording destination for each type of the first log;
a sending unit that sends the first log to a recording destination based on the destination information;
a log storage unit that stores therein the first log upon receiving from the sending unit; and
an information updating unit that updates the filter information and the destination information in response to an operation from outside, wherein
the information updating unit, upon completion of updating of the filter information, notifies the sorting unit of updated filter information,
the sorting unit sorts out the log based on the updated filter information from then on,
the information updating unit, upon completion of updating of the destination information, notifies the recording unit of updated destination information, and
the recording unit records the first log in a recording destination based on the updated destination information from then on.

2. The image forming apparatus according to claim 1, wherein the filter information contains information indicating a level of importance of the log, a process by which the log was created, and a thread by which the log was created.

3. The image forming apparatus according to claim 1, wherein the destination information contains a correspondence of a uniform resource identifier of a recording destination and a level of importance of the log.

4. The image forming apparatus according to claim 1, wherein the destination information contains a correspondence of a uniform resource identifier of a recording destination, a process, and a thread, the process and the thread being by which the log was created.

5. The image forming apparatus according to claim 1, further comprising an operating unit including
a display unit that displays the filter information and the destination information;
a first input unit for inputting character information; and
a second input unit for inputting positional information indicative of a position on the display unit, wherein
the information updating unit updates each of the filter information and the destination information in response to an operation of updating the filter information and the destination information from the operating unit.

6. The image forming apparatus according to claim 1, wherein
the information updating unit includes
a network communication unit that is connectable to a network;
a web contents generating unit that generates web contents to be used for displaying each of the filter information and the destination information on a web client over the network via the network communication unit;
an input receiving unit that receives operating information from the web client over the network via the network communication unit; and
an information setting unit that updates each of the filter information and the destination information based on the operating information.

7. The image forming apparatus according to claim 1, wherein
the information updating unit includes
a network communication unit that is connectable to a network;
a command receiving unit that receives an acquiring request and an updating request of each of the filter information and the destination information from a web client over the network via the network communication unit;
a responding unit that, upon receipt of the acquiring request by the command receiving unit, sends each of the filter information and the destination information as a response to the acquiring request over the network via the network communication unit; and
an information setting unit that, upon receipt of the updating request by the command receiving unit, updates each of the filter information and the destination information based on the updating request, wherein
the acquiring request, the updating request, and the response are written in an extensible markup language.
